(19) United States
(12) Patent Application Publication
(10) Pub. No.: US 2026/0112095 A1
(43) Pub. Date: Apr. 23, 2026

(54) METHOD AND SYSTEM FOR IMAGE RECONSTRUCTION FOR COMPUTER TOMOGRAPHY

(71) Applicant: FRIEDRICH-ALEXANDER-UNIVERSITÄT ERLANGEN-NÜRNBERG, IN VERTRETUNG DES FREISTAATES BAYERN, Erlangen (DE)

(72) Inventors: Darius RÜCKERT, Erlangen (DE); Philipp KURTH, Schwabach (DE)

(21) Appl. No.: 19/113,305

(22) PCT Filed: Oct. 16, 2024
(86) PCT No.: PCT/EP2024/079176

§ 371 Date: Mar. 19, 2025

(30) Foreign Application Priority Data
Oct. 18, 2023 (EP) EP23 204 306.7

(51) Int. Cl. G06T 12/30; G06T 12/20

(52) U.S. Cl. CPC G06T 12/30; G06T 12/20; G06T 2211/424; G06T 2211/448

(57) ABSTRACT

The present invention pertains to a method and system for image reconstruction for computer tomography, in particular for reducing beam hardening effects, wherein image reconstruction is performed based on the generalized Lambert-Beer law for poly-chromatic sources.

### CROSS-REFERENCE TO RELATED APPLICATIONS

The present application is a U.S. National Phase of International Application No. PCT/EP2024/079176 entitled “METHOD AND SYSTEM FOR IMAGE RECONSTRUCTION FOR COMPUTER TOMOGRAPHY,” and filed on Oct. 16, 2024. International Application No. PCT/EP2024/079176 claims priority to European Patent Application No. EP 23 204 306.7 filed on Oct. 18, 2023. The entire contents of each of the above-listed applications are hereby incorporated by reference for all purposes.

### TECHNICAL FIELD

The present invention is directed to a method and system for image reconstruction for computer tomography, in particular for reducing artefacts due to the beam hardening effect.

In recent decades, computed tomography (CT) has emerged as an indispensable imaging tool, finding applications in both industry and medicine. By providing detailed cross-sectional images of objects and organisms, CT has revolutionized industrial quality control and medical diagnostics.

However, despite its widespread adoption, the CT imaging quality is limited by physical effects, i.e. beam hardening and photon scattering, which are not handled correctly by prior art. The incorrect handling of these physical effects results in reconstruction artefacts illustrated by the figures of the present disclosure.

### BACKGROUND AND SUMMARY

As the X-ray beam passes through an object, higher-energy photons are attenuated less than lower-energy photons. This energy-dependent attenuation leads to a distortion known as beam hardening, causing objects to appear denser and resulting in the appearance of streaking and shading artefacts in the reconstructed images (as can be observed in the reconstruction result of prior art image reconstruction shown in the figures of the present disclosure).

An X-ray beam passing through an object is attenuated, where some photons are absorbed and others are scattered. The scattered photons hit the detector at a different pixel location compared to the unattenuated beam. The measured pixel intensity at the detector therefore is the sum of the unattenuated photons and scattered photons. Prior art reconstruction methods ignore photon scattering, which leads to additional artefacts especially in high-density material. These artefacts are shown in FIG. 6.

These artefacts due to beam hardening and scattering compromise the accuracy of measurements and hinder the ability to make precise diagnoses, imposing a critical challenge in both industrial and medical contexts.

It is an object of the present invention to alleviate or completely abolish the shortcomings of the prior art. In particular, it is a technical object of the present invention to provide a possibility of reducing or completely abolishing beam hardening artefacts in image reconstruction for computer tomography.

In this disclosure, a system and method is disclosed, which addresses the beam hardening problem in computed tomography, preferably by employing inverse photon simulation.

By use of the present invention, multi-material objects can be precisely reconstructed with a much reduced amount of artefacts or without any such artefacts at all, which enables accurate quality assessment, measurements, and diagnoses.

An aspect of the present invention is directed to a method for image reconstruction for computer tomography, wherein image reconstruction is performed based on the generalised Lambert-Beer law for polychromatic sources with photon scattering

$$I ( p ) = {\int }_{e = 0}^{{e}_{max}} {I}_{0} ( e ) exp ( - {\int }_{t = 0}^{{d}_{max}} - log ( μ ( {r}_{p} ( t ) , e ) ) dt ) de + S ( p ) \qquad [ Equation 1 ]$$

where I(p) is the intensity at pixel p, I₀(e) is the energy distribution of the source, rₚ the ray associated with pixel p, and μ(x,e) the energy-dependent absorption coefficient of the volume at position x and S(p) is the amount of incident scattered intensity at pixel p. The integration limits are eₘₐₓ, the maximum energy emitted by the source and dₘₐₓ, the distance between source and detector.

Current CT reconstruction algorithms known from the prior art follow the Lambert-beer law of photon attenuation:

$$I ( x ) = {I}_{0} exp ( - {\int }_{t = 0}^{{d}_{max}} - log ( μ ( {r}_{p} ( t ) ) ) dt ) \qquad [ Equation 2 ]$$

This model, however, is insufficient due to the polychromatic properties of x-ray sources, often employed for CT imaging, as has been recognized by the inventors of the present invention. In other words, this model, is insufficient due to the polychromatic properties of x-ray sources and the photon scattering effect. A reconstruction using Eq. 2 leads to severe image artefacts as shown in figures included in this disclosure.

The present innovation can comprise a method, including e.g. an iterative algorithm, and computer program configured to solve equation 1 for all parameters simultaneously.

Prior art CT reconstruction either uses the simplified model of equation 2 or solves equation 1 using prior knowledge of some parameters. However there is no prior art that can optimise all parameters of equation 1 simultaneously preferably without any prior knowledge of at least some of the parameters of equation 1.

In contrast, the present invention directly solves equation 1 without prior knowledge. As an underlying principle, differentiable Monte Carlo simulation of Xray photons is used. The differentiability of the simulation allows a method according to the present invention to optimise each parameter or a subset of parameters of equation 1 using backpropagation.

The present invention can therefore be applied to all existing CT-systems and objects to be scanned.

An exemplary work flow for one iteration of a method according to the present invention is shown in FIG. 4. To get the final result, the steps shown in FIG. 4 or a subset thereof are preferably executed several times until the desired reconstruction quality is achieved.

In addition, a method according to the present invention can encompass a step of using inverse photon simulation.

According to an embodiment of the invention, the method comprises the step: Solving Equation 1 by using an iterative algorithm based on differentiable Monte-Carlo simulation of photons.

In at least one iteration or in each iteration of the iterative algorithm, a number of n pixels can be randomly selected across all projections of a number of projections present in the image data.

Preferably, for each pixel, a number of k energy samples are drawn from a current estimate of a source energy distribution. The source energy distribution preferably is the distribution of energy at an energy source of a CT device.

A method according to the present invention can further comprise the step: tracing at least one of the k energy samples through a volume using the inner integral of Equation 1 thereby obtaining a transmission probability of an energy level associated with the at least one energy sample.

Preferably, the step of tracing is performed for all k energy samples and based on the result of the tracing an estimated intensity Î(p) at a detector element, preferably of a CT device, is obtained.

A method according to the present invention can further comprise a step of comparing the estimated intensity I\hat{ }(p) with a measured intensity I(p) at the detector element, generating a gradient from the comparison and preferably backpropagating the gradient through the Monte-Carlo photon simulation.

A method according to the present invention can further comprise an optimization step comprising adapting at least one parameter, a subset of parameters or all parameters of Equation 1, preferably parameters I₀(e) and/or μ(x, e).

Another aspect of the present invention pertains to a system configured to perform a method according to the present invention. The system can comprise or consist of a computer tomography device and/or a computer.

A further aspect of the invention pertains to a computer program product comprising machine executable instructions causing a system executing the instructions to perform a method according to the present invention.

Yet another aspect to the present invention pertains to a computer-readable medium comprising a computer program product according to the present invention.

A further aspect of the present invention pertains to a use of a method and/or a system and/or a computer program product and/or a computer-readable medium according to the present invention for imaging of an object, for quality control in manufacture, in particular industrial manufacture of goods, and/or in the medical field, in particular for medical imaging and/or diagnosis.

Preferably, the use is applied to an object comprising at least two different materials, preferably selected from the following group: metal, polymer, glass, tissue, bone. In other words, the method and/or a system and/or a computer program product and/or a computer-readable medium according to the present invention is preferably used for imaging of an object, comprising at least two different materials, preferably selected from the following group: metal, polymer, glass, tissue, bone.

Such an object can be e.g. a camera lens comprising, metal, polymer and glass or a patient comprising soft tissue, bone and e.g. a metal implant.

It is to be noted that the present disclosure is not limited to the feature combinations explicitly recited herein, but that all features disclosed may also be claimed in isolation or in any desirable combination.

Furthermore, it is to be understood that the articles in singular “a” or “an” are not to be construed as “only one” but are to be understood as “at least one”. Thus, elements disclosed with an article in singular may also be present in plural and vice versa.

### BRIEF DESCRIPTION OF THE FIGURES

Further features and effects are disclosed in the following description of the figures. In the figures,

FIG. 1a) shows a CT-image of a circuit board using conventional image reconstruction.

FIG. 1b) shows a CT-image of the same circuit board as in FIG. 1a) using image reconstruction according to the present invention.

FIG. 2a) shows a CT-image of a camera lens using conventional image reconstruction.

FIG. 2b) shows a CT-image of the same camera lens as in FIG. 2a) using image reconstruction according to the present invention.

FIG. 3 shows a flow chart of a method according to an embodiment of the invention.

FIG. 4 shows another flow chart of a method according to an embodiment of the invention.

FIG. 5a) shows a CT-image of a telephone and a computer chip using conventional image reconstruction.

FIG. 5b) shows a CT-image of the same telephone and computer chip as in FIG. 5a) using image reconstruction according to the present invention.

FIG. 6a) shows a CT-image of a high-absorption electric motor using conventional image reconstruction.

FIG. 6b) shows a CT-image of the same high-absorption electric motor as in FIG. 6a) using image reconstruction according to the present invention.

### DETAILED DESCRIPTION

As can be clearly seen from the figures, the present invention achieves much clearer images with much less distortion due to beam hardening effects. The present invention demonstrates a significant reduction in beam hardening artifacts, addressing a long-standing challenge in computed tomography.

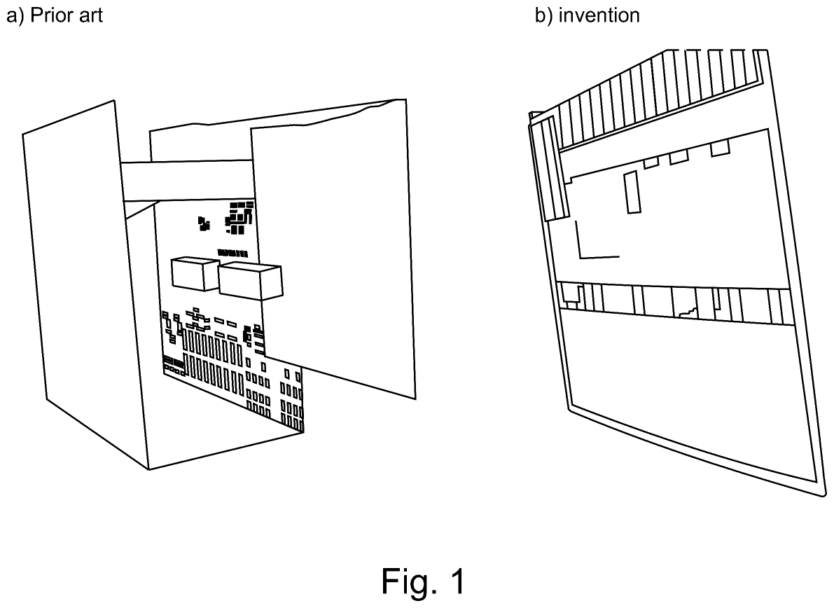

In FIG. 1, a comparison is presented between image reconstruction results of a method according to the present invention and image reconstruction results obtained using a state-of-the-art iterative reconstruction provided by the Astra Toolbox, where the latter fails to accurately reconstruct the multi-material circuit board.

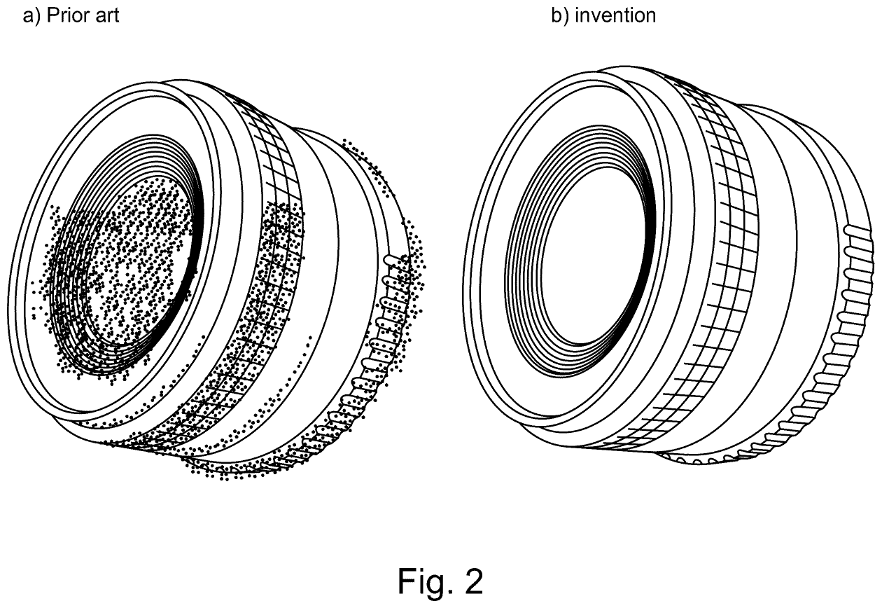

Furthermore, FIG. 2 illustrates the superior image reconstruction achievable with the present invention. The lens features materials of different densities, from the rubber grip band to various metal components and the glass lenses.

With the present invention, the boundaries between these components are much more pronounced and sharper.

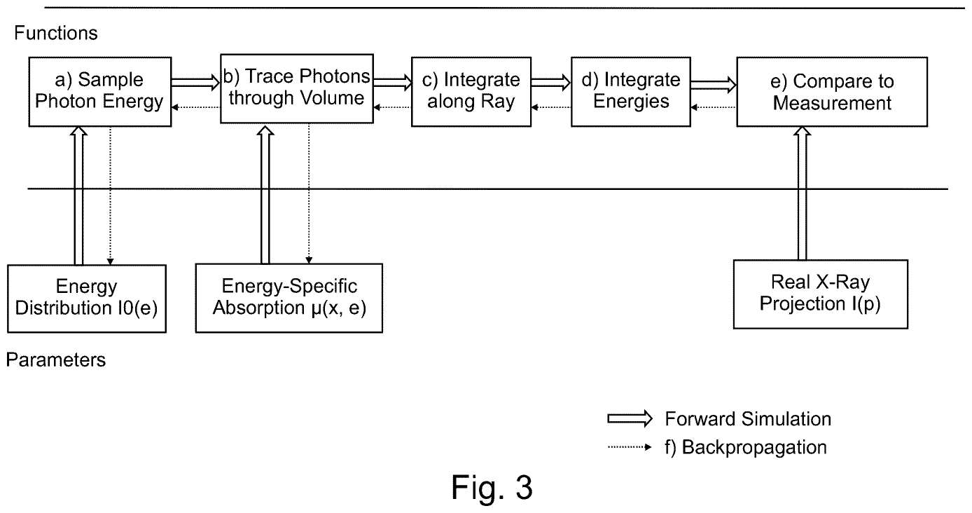

Further, the exemplary embodiment of the invention of FIG. 3 is described: In order to solve Equation (1), a novel iterative algorithm (as illustrated in FIG. 3) based on differentiable Monte-Carlo simulation of photons is used. This algorithm is outlined in FIG. 3 and described in the following. In the embodiment of FIG. 3, the algorithm comprises steps a) to f), but not all of these steps have to be present. The steps are explained below.

Step a) In each iteration, a number of n pixels are randomly selected across all projections. For each pixel, k energy samples are drawn from the current estimate of the source's energy distribution I0(e).

Step b) The corresponding photons are traced along rays through the volume and the absorption μ(x, e) is evaluated at each spatial location x using the photon's energy e.

Step c) The absorption values are integrated using the inner integral of Eq. (1). This results in the transmission probability of a photon with the energy e. For an efficient computation, the integral can be replaced by a finite sum of discretized volume samples during the reconstruction.

Step d) All photons that correspond to the same ray are integrated using the outer integral of Eq. (1) together with the energy distribution I0(e). The result is the estimated X-ray intensity at the detector pixel I\hat{ }(p), which corresponds to the given ray. Similar to c), the integral is discretized to a finite sum over the k energy samples that have been drawn in a).

Step e) Finally, the estimated intensity I\hat{ }(p) is compared to the measured intensity I(p) using the mean-square error (MSE) resulting in a gradient g for the pixel p.

Step f) The pixel gradient g is propagated back through the photon simulation as depicted by the dashed arrows in FIG. 3. Once the gradient reaches the parameters I0(e) and μ(x, e), backpropagation is finished and the parameters are optimized using gradient decent.

During the reconstruction, the steps a)-f) are preferably repeated until convergence or a maximum number of iterations is reached. In the end, the volume (x, e) is obtained, which can be used for analysis and diagnostic tasks.

A method according to the present inventions defined in claim 1 can comprise any one or more of steps a) to f) in any desirable combination.

The present invention offers a solution for eliminating beam hardening artifacts in multi-material objects, thus significantly improving image quality.

This advancement has wide-ranging applications, particularly in the fields of industrial quality assurance and measurements, where many objects consist of a combination of plastic and metal components. With reduced image artifacts, defects can now be detected more accurately, minimizing the occurrence of false positives.

Additionally, in the medical field, the present invention enables accurate diagnosis for patients with metal implants, overcoming the challenges posed by strong artifacts that previously hindered precise imaging and analysis.

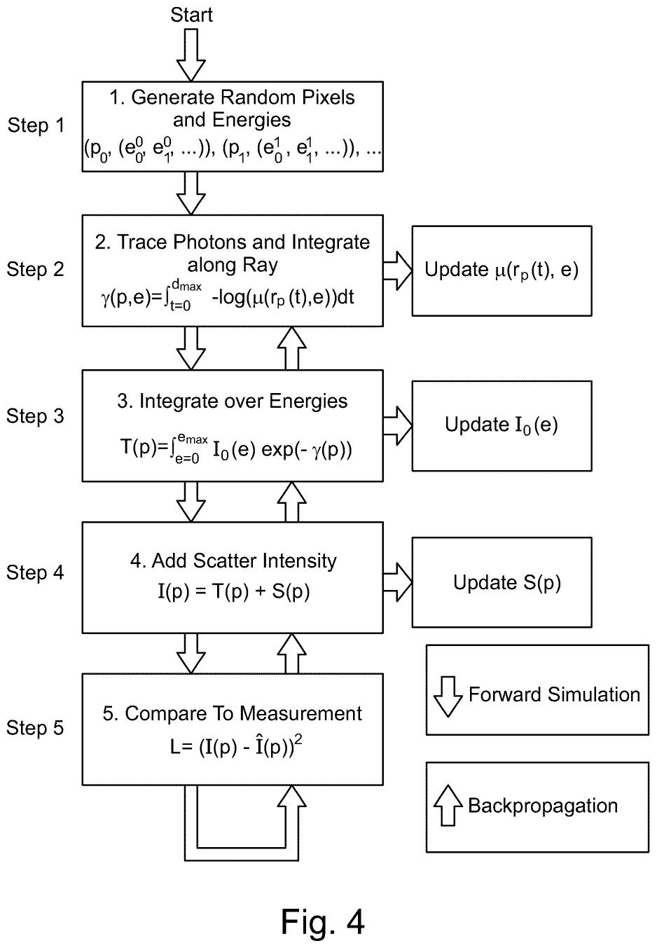

FIG. 4 shows in detail an embodiment of a method according to the present invention.

The steps shown in FIG. 4 show one iteration of method in that these steps or a subset thereof are repeated until a desired image quality is achieved.

The forward simulation (downwards arrows) computes the expected image intensity for a random selection of pixels and energies. Using the measured X Ray-projections, the gradient of the loss function is evaluated and then backpropagated to the input parameters (upward arrows)

In each iteration of the iterative algorithm, a number of n pixels can be randomly selected across all projections. Preferably, for each of the selected pixels, a number of k energy samples are drawn. (See FIG. 4, Step 1.)

A method according to the present invention can further comprise the step: tracing for at least one of the selected pixels, at least one of the k energy samples through a volume using the inner integral of Equation 1 thereby obtaining a transmission probability γ(p,e) of the associated energy level. Preferably, the step of tracing is performed for all k energy samples and all n pixels. (See FIG. 4, Step 2.)

All energy samples belonging to the same pixel are then integrated using the transmission probability γ(p,e) and the energy distribution I0(e). The result is the transmission intensity T(p) of the primary beam (without scattering) (See FIG. 4, Step 3.)

As a next step, the estimated scatter intensity S(p) is added to the transmission intensity T(p) resulting in the predicted intensity I(p) at the detector pixel p. (See FIG. 4 Step 4.)

A method according to the present invention can further comprise a step of comparing the estimated intensity I(p) with a measured intensity I\hat{ }(p) at the detector element, generating a gradient from the comparison and preferably backpropagating the gradient through the Monte-Carlo photon simulation. (See FIG. 4 Step 5.)

Steps 3, 4 and 5 or any desirable subset thereof can comprise a step of backpropagation to the previous step, as e.g. indicated by the upward arrows in FIG. 4.

Steps 2, 3 and 4 or any desirable subset thereof can comprise a step of updating the parameters used by the method, e.g. as indicated in FIG. 4.

A method according to the present invention can further comprise an optimization step comprising adapting at least one parameter, a subset of parameters or all parameters of Equation 1, preferably parameters I0(e) and/or μ(x, e) and/or S(p).

The parameters I0(e), μ(x, e) and S(p) can be modelled as parametric functions to reduce the complexity of equation 1 and get rid of ambiguities. Preferably these functions are differentiable and simple to compute like polynomials or piecewise linear functions.

The initialization of the parameters I0(e), μ(x, e) and S(p) is arbitrary. Preferably the parameters are initialised randomly in a reasonable range or to zero.

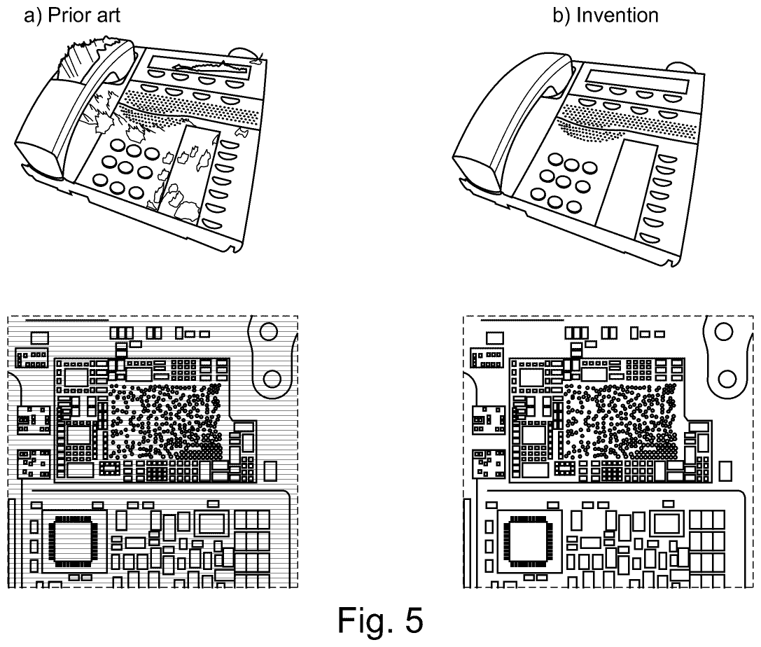

As shown in FIG. 5, top panel, a CT reconstruction using a prior art technique of a telephone with plastic housing and several metal components inside suffers from severe streaking artefacts due to the beam hardening effect.

The same holds true for FIG. 5, lower panel. In the prior art reconstruction image, horizontal stripe artefacts are visible. Furthermore, the overall image quality is significantly worse compared to the reconstruction with the present invention.

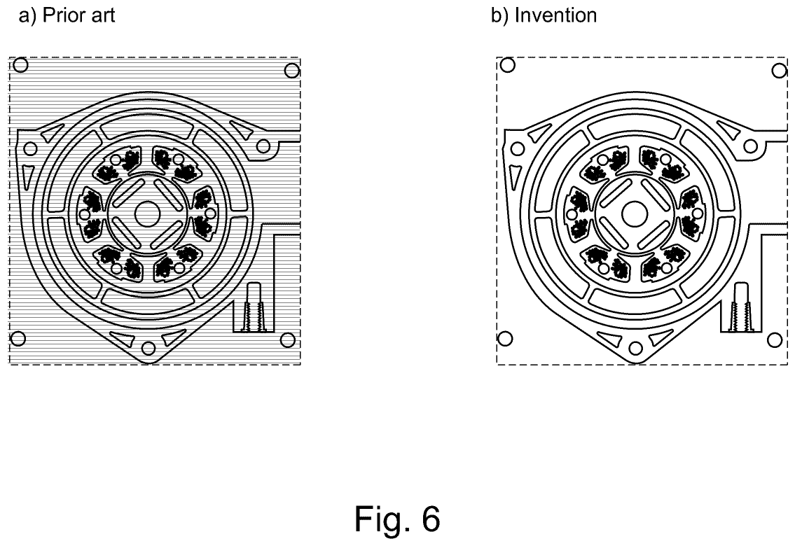

FIG. 6 shows a CT reconstruction using prior art and the present invention of a high-absorption electric motor. Due to beam hardening and scattering the prior art method creates severe artefacts and cannot estimate the correct density of the copper and steel parts.

1. Method for image reconstruction for computer tomography, in particular for reducing beam hardening and scattering artefacts, wherein image reconstruction is performed based on the generalized Lambert-Beer law for polychromatic sources with scattering term
$$I ( p ) = {\int }_{e = 0}^{{e}_{max}} {I}_{0} ( e ) exp ( - {\int }_{t = 0}^{{d}_{max}} - log ( μ ( {r}_{p} ( t ) , e ) ) dt ) de + S ( p ) \qquad [ Equation 1 ]$$
where I(p) is the intensity at pixel p, I₀(e) is the energy distribution of the source, rₚ the ray associated with pixel p, μ(x,e) the energy-dependent absorption coefficient of the volume at position x, and S(p) is the amount of incident scattered intensity at pixel p, wherein the integration limits are eₘₐₓ, the maximum energy emitted by an source during imaging of an object and dₘₐₓ, the distance between the energy source and a detector used during imaging of the object.

2. Method according to claim 1, comprising the step: Solving Equation 1 by using an iterative algorithm based on differentiable Monte-Carlo simulation of photons.

3. Method according to claim 2, wherein in each iteration of the iterative algorithm, a number of n pixels is randomly selected across all projections of a number of projections.

4. Method according to claim 3, wherein for each pixel, a number of k energy samples are drawn.

5. Method according to claim 4, further comprising the step: tracing for at least one of the selected pixels, at least one of the k energy samples through a volume using the inner integral of Equation 1 thereby obtaining a transmission probability γ (p,e) of an energy level associated with the at least one energy sample.

6. Method according to claim 5, wherein a step of integrating all energy samples belonging to the same pixel is performed herby obtaining a transmission intensity T(p) of the primary beam.

7. Method according to claim 6, wherein the estimated scatter intensity S(p) is added to the transmission intensity T(p) resulting in the predicted intensity I(p).

8. Method according to claim 6, further comprising a step of comparing the estimated intensity I\hat{ }(p) with a measured intensity I(p) at a detector element, generating a gradient from the comparison and preferably backpropagating the gradient through the Monte-Carlo photon simulation.

9. Method according to claim 6, further comprising an optimization step comprising adapting at least one parameter, a subset of parameters or all parameters of Equation 1, preferably parameters I₀(e) and/or μ(x, e) and/or S(p).

10. System configured to perform a method according to claim 1.

11. System according to claim 10, wherein the system comprises or consists of a computer tomography device.

12. Computer program product comprising machine executable instructions causing a system executing the instructions to perform a method according to ene of claim 1.

13. Computer-readable medium comprising a computer program product according to claim 12.

14-15. (canceled)
